(19) United States
(12) Patent Application Publication
(10) Pub. No.: US 2022/0017042 A1
(43) Pub. Date: Jan. 20, 2022

(54) METHOD, APPARATUS AND DEVICE FOR ACTIVATING VEHICLE, AND STORAGE MEDIUM

(71) Applicant: Nine Intelligent (Changzhou) Tech Co.,Ltd., Changzhou City (CN)

(72) Inventors: Shengqiao ZHANG, Changzhou City (CN); Jie LUO, Changzhou City (CN); Long FU, Changzhou City (CN)

(21) Appl. No.: 17/372,707

(22) Filed: Jul. 12, 2021

(30) Foreign Application Priority Data
Jul. 14, 2020 (CN) 202010676191.9

(51) Int. Cl. B60R 25/23; G06F 21/31; B62H 5/00; B62J 50/22; B62J 45/20

(52) U.S. Cl. CPC B60R 25/23; G06F 21/31; B62J 45/20; B62J 50/22; B62H 5/00

(57) ABSTRACT

Provided are a method, an apparatus and a device for activating a vehicle. The method includes: acquiring at least one set of operations for a password input key of the vehicle; acquiring an activation password of the vehicle according to the at least one set of operations; and activating the vehicle according to the activation password; wherein the activation password includes at least one character, and each character of the at least one character is acquired according to the number of operations and/or an operation duration of each set of the at least one set of operations.

### CROSS-REFERENCE TO RELATED APPLICATION

This application claims priority to and benefits of Chinese Patent Application Serial No. 202010676191.9, filed with the National Intellectual Property Administration of P. R. China on Jul. 14, 2020, the entire content of which is incorporated herein by reference.

### FIELD

The present disclosure relates to a field of vehicle activating technologies, and more particularly to a method, an apparatus and a device for activating a vehicle, and a storage medium.

### BACKGROUND

In the related art, for a vehicle such as an electric bicycle and an electric motorcycle, a key or a mobile phone is used to activate or turn on the vehicle. In this case, the activation of the vehicle relies on the physical body of the key or the mobile phone. When the key or mobile phone is forgotten, the vehicle cannot be activated or turned on.

### SUMMARY

In order to achieve the above-mentioned object, the present disclosure provides in embodiments a method, an apparatus and a device for activating a vehicle, and a storage medium.

In a first aspect of the present disclosure, a method for activating a vehicle is provided. The method includes: acquiring at least one set of operations for a password input key of the vehicle; acquiring an activation password of the vehicle according to the at least one set of operations; and activating the vehicle according to the activation password; wherein the activation password includes at least one character, and each character of the at least one character is acquired according to the number of operations and/or an operation duration of each set of the at least one set of operations.

The present disclosure provides in embodiments of a second aspect a non-transitory computer-readable storage medium having stored therein a computer program that, when executed by a processor, is configured to perform steps of the method as described above.

In a third aspect of the present disclosure, a device for activating a vehicle is provided. The device includes a processor; a memory having stored herein a computer program that, when executed by the processor, causes the processor to perform steps of the method as described above.

### BRIEF DESCRIPTION OF THE DRAWINGS

These and other aspects and advantages of embodiments of the present disclosure will become apparent and more readily appreciated from the following descriptions made with reference to the drawings. It should be noted that the drawings described below are only illustrated. Those skilled in the art can obtain other drawings according to the following drawings without inventive work.

FIG. 1 is a flow chart of a method for activating a vehicle according to an embodiment of the present disclosure.

FIG. 2 is a flow chart of a method for activating a vehicle according to another embodiment of the present disclosure.

FIG. 3 is a flow chart of a method for activating a vehicle according to a further embodiment of the present disclosure.

FIG. 4 is a flow chart of a method for activating a vehicle according to a still further embodiment of the present disclosure.

FIG. 5 is a schematic diagram of an electric bicycle according to an embodiment of the present disclosure.

FIG. 6 is a schematic diagram of an electric bicycle according to another embodiment of the present disclosure.

FIG. 7 is a block diagram of an apparatus for activating a vehicle according to an embodiment of the present disclosure.

FIG. 8 is a schematic diagram of hardware configuration of a device for activating a vehicle according to an embodiment of the present disclosure.

### DETAILED DESCRIPTION

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and used to generally understand the present disclosure. The embodiments shall not be construed to limit the present disclosure. It should be noted that various embodiments or examples described in the specification, as well as features of such the embodiments or examples, may be combined without conflict. Steps of the flow charts shown in the drawings may be executed in a computer system such as a set of computer-executable instructions. Although a logical sequence is shown in the flow chart, the steps shown or described may be performed in a different order.

In order to achieve the above-mentioned object, the present disclosure provides in embodiments a method, an apparatus and a device for activating a vehicle, and a storage medium, which are capable of activating or turning on the vehicle without relying on the physical body of the key or the mobile phone, thus improving the user's experience.

In a first aspect of the present disclosure, a method for activating a vehicle is provided. The method includes: acquiring at least one set of operations for a password input key of the vehicle; acquiring an activation password of the vehicle according to the at least one set of operations; and activating the vehicle according to the activation password; wherein the activation password includes at least one character, and each character of the at least one character is acquired according to the number of operations and/or an operation duration of each set of the at least one set of operations.

In an embodiment of the present disclosure, the method further includes: acquiring an operation for a password activation key of the vehicle, to allow the vehicle to enter a password activation mode; and acquiring the at least one set of operations for the password input key of the vehicle in the password activation mode.

In an embodiment of the present disclosure, before activating the vehicle according to the activation password, the method further includes: acquiring an operation for confirming the activation password; and determining whether the activation password is a correct password according to the acquired operation for confirming the activation password. Activating the vehicle according to the activation password includes: activating the vehicle with the activation password when it is determined that the activation password is the correct password.

In an embodiment of the present disclosure, the activation password includes two or more characters, and wherein acquiring an operation for confirming the activation password; and determining whether the activation password is a correct password according to the acquired operation for confirming the activation password include: acquiring a current character of the activation password, and acquiring an operation for confirming the current character; determining that the current character is a correct character according to the acquired operation for confirming the current character; and determining that the activation password is the correct password when each character of the activation password is a correct character.

In an embodiment of the present disclosure, the activation password includes two or more characters, and wherein acquiring an operation for confirming the activation password; and determining whether the activation password is a correct password according to the acquired operation for confirming the activation password include: acquiring a current character of the activation password, and acquiring an operation for confirming the current character; and acquiring the operation for confirming the activation password when a last character of the activation password is acquired.

In an embodiment of the present disclosure, each character independently is a value of the number of operations performed on the password input key in each set of operations, or a letter corresponding to the number of operations; and/or each character independently is a value of a duration of an operation performed on the password input key in each group of operations, or a letter corresponding to the duration of the operation.

In an embodiment of the present disclosure, when the vehicle enters the password activation mode, the method further includes: time-counting to acquire a duration; when the duration reaches a predetermined duration, exiting the password activation mode if not all operations in the at least one set of operations are acquired; and/or exiting the password activation mode when the duration reaches the predetermined duration.

In an embodiment of the present disclosure, the vehicle further includes a display screen; and wherein the operation performed on the password input key in each set of operations is at least one pressing operation, and in each set of operations, every time the pressing operation is performed on the password input key, the display screen is controlled to display a corresponding value of the number of pressing operations until the pressing operations performed on the password input key in each set of operations are completed.

In an embodiment of the present disclosure, the operation for confirming the activation password is an operation for a brake button of the vehicle, and/or a touch operation for a display screen of the vehicle.

In a second aspect of the present disclosure, an apparatus for activating a vehicle is provided. The apparatus includes: a first acquiring unit, configured to acquire at least one set of operations for a password input key of the vehicle, wherein the password input key is used for a user to input an activation password; a second acquiring unit, configured to acquire the activation password of the vehicle according to the at least one set of operations; and an activation unit, configured to activate the vehicle according to the activation password; wherein the activation password includes at least one character, and each character of the at least one character is acquired according to the number of operations and/or an operation duration of each set of the at least one set of operations.

The present disclosure provides in embodiments of a third aspect a non-transitory computer-readable storage medium having stored therein a computer program that, when executed by a processor, is configured to perform steps of the method as described above.

In a fourth aspect of the present disclosure, a device for activating a vehicle is provided. The device includes a processor; a memory having stored herein a computer program that, when executed by the processor, causes the processor to perform steps of the method as described above.

The present disclosure provides in embodiments the method, the apparatus and the device for activating the vehicle and the storage medium. The method includes: acquiring at least one set of operations for a password input key of the vehicle; acquiring an activation password of the vehicle according to the at least one set of operations; and activating the vehicle according to the activation password; wherein the activation password includes at least one character, and each character of the at least one character is acquired according to the number of operations and/or a duration of an operation of each set of the at least one set of operations.

In the embodiments of the present disclosure, the number of operations and/or the duration of the operation of each set performed on the password input key by the user are used to identify the activation password input by the user. Even if the user forgets to wear or carry the key or the mobile phone, the activation password can be identified to realize the activation of the vehicle, which improves the user's experience. In the present disclosure, the vehicle is provided with an additional function that is capable of activating or turning on the vehicle with the password, which improves intelligent control of the vehicle. In addition, the character(s) constituting the activation password can be determined by the number of operations and/or the operation duration of each set of operations performed on the password input key, which improves convenience and flexibility for inputting the password, and thus provides convenience to the user. In the present disclosure, the vehicle can be activated or turned on normally without relying on physical body of the key or the mobile phone, and thus the user's experience can be improved.

The vehicle in the embodiments of the present disclosure may be any accessible device that can be activated with a password, such as an electric bicycle, an electric motorcycle, and a roller skating equipment. For example, the vehicle in the embodiments of the present disclosure is an electric bicycle or an electric motorcycle. The technical solution of the present disclosure will be further described below.

The embodiments of the present application provides a method for activating a vehicle, which is applied to an appliance having at least a password input key. The password input key may be a physical key or a virtual key. In actual implementations, the password input key may be an existing function key on the vehicle. When the vehicle enters the password activation mode, the function key is used as the password input key. When the vehicle is activated, the function key is in accordance with its corresponding original function. Alternatively, the password input key can be a key additionally provided on the vehicle, or a key multiplexed with other existing key of the vehicle, such as a switch button, which is not specifically limited herein.

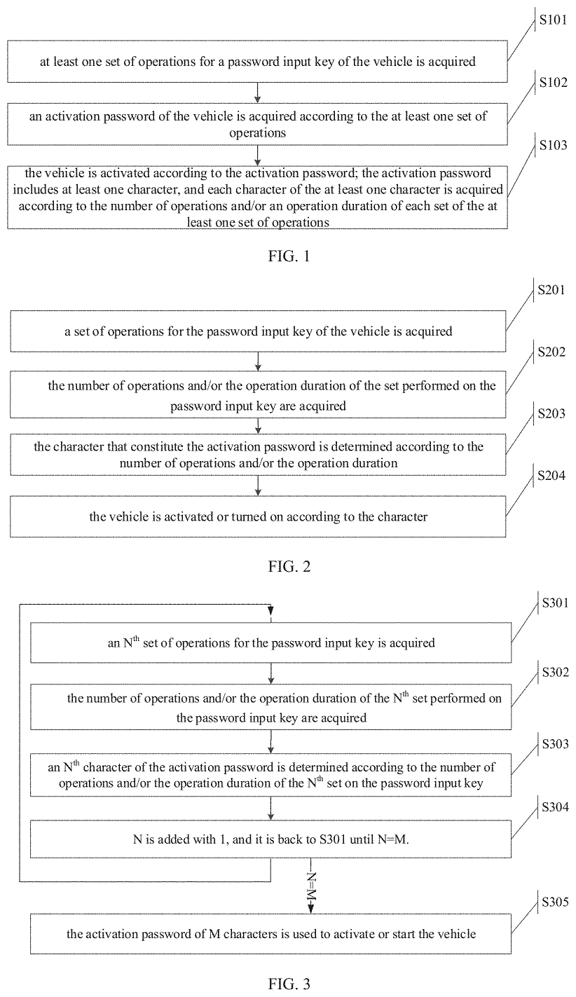

As shown in FIG. 1, the method includes the following steps.

In S101, at least one set of operations for a password input key of the vehicle is acquired.

In this step, the password input key is used for the user to input the activation password. The user may input the password by an operation such as a touch operation on the password input key. Specifically, when the password input key is a physical button, the touch operation may be a pressing operation, a clicking operation, and the like. When the password input key is a virtual key, the touch operation may be a sliding operation in addition to pressing and clicking. For this, no specific restriction is made herein. At least one set of operations for the password input key is detected or monitored, and each set of operations includes at least one of the above operation.

In S102, an activation password of the vehicle is acquired according to the at least one set of operations.

In S103, the vehicle is activated according to the activation password. The activation password includes at least one character, and each character of the at least one character is acquired according to the number of operations and/or an operation duration of each set of the at least one set of operations.

In S103, the activation password may be only one character or consist of at least two characters. The character may be a number, a letter, and/or a symbol representing a certain meaning, such as * and &. Each set of operations performed on the password input key determines what character each character in the activation password is. That is, each character of the activation password is determined according to operation attributes of the corresponding set of operations, for example, the number of operations and/or the operation duration.

As described in steps S101 to S103, the user can input the activation password of the vehicle through the operation for the password input key. The vehicle can be activated by the activation password input by the user. In the technical level, the number of the operations and/or the operation duration of each set performed on the password input key are used to identify the activation password input by the user. Even if the user forgets to wear or carry the key or the mobile phone, with the technical solution provided in the present disclosure, the activation password can be identified to realize the activation of the vehicle, which improves the user's experience. In the present disclosure, the vehicle is provided with an additional function that is capable of activating or turning on the vehicle with the password, which improves intelligent control of the vehicle. In addition, the character(s) constituting the activation password can be determined by the number of operations and/or the operation duration of each set performed on the password input key, which improves convenience and flexibility for inputting the password, and thus provides convenience to the user.

S101 and S102 can be regarded as the process of acquiring the activation password according to the number of operations or the operation duration of at least one set of operations performed by the user on the password input key of the vehicle. For brief and clear description, this process can be regarded as a password identification using the operation performed by the user on the password input key.

In practical applications, after S102, the acquired activation password may be compared with a preset activation password of the vehicle. If they are the same, S103 is performed, otherwise, the process ends.

In the following, S101 to S103 will be further described with examples that the activation password is one character or two or more characters.

In an embodiment, the activation password is one character (bit). Operation(s) for inputting the activation password, generated on the password input key by the user, is regarded as one set of operations. The method including S101 to S103 is realized by the following steps as shown in FIG. 2.

In S201, a set of operations for the password input key of the vehicle is acquired.

In S202, the number of operations and/or the operation duration of the set performed on the password input key are acquired.

In S203, the character that constitute the activation password is determined according to the number of operations and/or the operation duration.

In S204, the vehicle is activated or turned on according to the character.

In an embodiment, the activation password are two or more characters (bits). Operations for inputting the activation password, generated on the password input key by the user, are regarded as two or more sets of operations. The method including S101 to S103 is realized by the following steps as shown in FIG. 3.

Parameters N and M are preset, and N and M independently are positive integers greater than or equal to 1. M represents the number of characters of the activation password. An initial value of N is set to 1.

In S301, an N^{th} set of operations for the password input key is acquired.

In S302, the number of operations and/or the operation duration of the N^{th} set performed on the password input key are acquired.

In S303, an N^{th} character of the activation password is determined according to the number of operations and/or the operation duration of the N^{th} set performed on the password input key.

In S304, N is added with 1, and it is back to S301 until N=M.

With S301 to S304, each character that constitutes the activation password can be acquired, and S305 is performed, that is, the activation password of M characters (M bits of characters) is used to activate or start the vehicle.

In the process of S201 to 204 or S301 to S305, one set of operations performed on the password input key corresponds to one character that constitutes the activation password. When there are two or more characters constituting the activation password, each character of the activation password is obtained by each set of operations for the password input key, specifically the number of operations or the duration of the operation of each set of operations. Therefore, the vehicle can be activated or turned on with the password. Compared with the use of the physical body of the key or the mobile phone in the related art, the present technical solution may be used to activate or start the vehicle anytime and anywhere, without meeting constraints of time or the physical body of the key and mobile phone, and thus is more flexible.

In the process of S202 and S203 or S302 and S303, for any one of the characters, the determination of the character may be related to the total number of operations of the corresponding set performed on the password input key, and may also be related to the duration of the operation of the corresponding set. The character may be a number or a letter. That is, each character constituting the activation password is a value of the number of operations performed on the password input key in each set of operations (when the character is a number), or a letter corresponding to the number of operations (when the character is a letter).

It is also possible that each character constituting the activation password is a value of the duration of the operation in each set of operations performed on the password input key (when the character is a number), or a letter corresponding to the duration of the operation (when the character is a letter).

In an embodiment, when a set of operations for the password input key is detected, the number of operations of this set performed on the password input key is calculated, and/or the duration of the operation of this set is monitored.

In an embodiment, the character is determined according to the number of operations.

For example, the character that constitutes the activation password is a number, and the value of the number is the number of operations of the set of operations performed on the password input key. If the number of operations is 5, the character that constitutes the activation password is a number 5. It can be understood that when the character is a number, the character can be any number, such as from 0 to 9, from 10 to 99, and from 100 to 999. In practical applications, it is normally in a range of 0 to 9.

For another example, the character that constitutes the activation password is a letter which belongs to the alphabet of 26 letters. The letter is determined according to the number of operations of the corresponding set of operations performed on the password input key and a preset corresponding relationship (i.e., a first corresponding relationship). In practical applications, there are 26 English letters, and the corresponding relationship between the letter and the number of operations is preset. It is preset that the number of operations is a rank of a letter in a normal order in the 26 English letters. For example, letter A or a is a first letter in the 26 letters, and the number of operations corresponding to this letter in the corresponding relationship is 1. For another example, letter B or b is a second letter in the 26 letters, and the number of operations corresponding to this letter in the corresponding relationship is 2. Alternatively, it is preset that the number of operations is a rank of a letter in a reversed order in the 26 English letters. For example, letter Z or z is a 26^{th} letter in the 26 letters, and the number of operations corresponding to this letter in the corresponding relationship is 1. For another example, letter Y or y is a 25^{th} letter in the 26 letters, and the number of operations corresponding to this letter in the corresponding relationship is 2. In a case where the number of operations performed on the password input key is 2, according to the preset first corresponding relationship, it may be determined that the character is the letter B or b (based on the normal order of the letter). If the reversed order is used, the character is the letter Y or y. Therefore, automatic recognition of the password character can be realized based on the number of operations on the password input key, which is easy to realize in engineering and may be widely applied.

In another embodiment, the character is determined according to the duration of the operation. In practical applications, the duration may be in seconds or in minutes. In the following description, the duration is in seconds.

For example, the character that constitutes the activation password is a number, and the value of the number is the duration of the operation of the set performed on the password input key. If the duration of the operation in this set that is monitored on the password input key is 5 s, the character that constitutes the activation password is a number 5.

For another example, the character that constitutes the activation password is a letter which belongs to the alphabet of 26 letters. The letter is determined according to the duration of the operation of the corresponding set performed on the password input key and a preset corresponding relationship (i.e., a second corresponding relationship). In practical applications, there are 26 English letters, and the corresponding relationship between the letter and the duration of the operation is preset. It is preset that the duration of the operation is a rank of a letter in a normal order in the 26 English letters. For example, letter A or a is a first letter in the 26 letters, and the duration of the operation corresponding to this letter in the corresponding relationship is 1 s. For another example, letter B or b is a second letter in the 26 letters, and the duration of the operation corresponding to this letter in the corresponding relationship is 2 s. Alternatively, it is preset that the duration of the operation is a rank of a letter in a reversed order in the 26 English letters. For example, letter Z or z is a 26^{th} letter in the 26 letters, and the duration of the operation corresponding to this letter in the corresponding relationship is 1 s. For another example, letter Y or y is a 25^{th} letter in the 26 letters, and the duration of the operation corresponding to this letter in the corresponding relationship is 2 s. In a case where the duration of the operation performed on the password input key is 2 s, according to the preset second corresponding relationship, it may be determined that the character is the letter B or b (based on the normal order of the letter). If the reversed order is used, the character is the letter Y or y. Therefore, automatic recognition of the password character can be realized based on the duration of the operation of one set on the password input key, which is easy to realize in engineering and may be widely applied.

In the embodiments of the present disclosure, the number of operations of each set may be used to determine a corresponding character of the activation password, and the duration of the operation of each set may also be used to determine a corresponding character of the activation password. Moreover, a character of the activation password may be determined according to the number of operations and the duration of the operation. For example, one set of operations on the password input key is monitored, the number of operations of this set is 2, and each operation is performed for ls, that is, a total operation duration of this set is 2 s. When a character corresponding to this set of operations is a number, the number is 2 from the perspective of the number of operations, and the number is 2 from the perspective of the operation duration. From the perspective of the number of operations and the duration of this set, the results are the same, and the number can be finally confirmed as 2. This is, in this example, the same result is obtained from the perspectives of both operation duration and the number of operations. When the results obtained from these two perspectives are inconsistent, such as the number obtained from one perspective is 2, and the result obtained from the other perspective is 3, this set of operations performed on the password input key is regarded as invalid. A next set of operations for the password input key will be monitored.

In the embodiments of determining a character according to the number of operations and/or the duration of the operation. Each set of operations may be operations performed on a physical password input key (that is, the password input key is a physical key), or a virtual password input key (that is, the password input key is a virtual key). In a case where the character identification is based on each set of operations performed on the physical password input key, the operation performed on the key may be a pressing operation or a click operation, the operation duration may be a pressing duration or a clicking duration, and the number of operations may be the number of pressing operations or clicking operations. In a case where the character identification is based on each set of operations performed on the virtual password input key, the operation performed on the key may be a sliding operation in addition to a pressing operation or a click operation. On this basis, the operation duration may be a sliding duration, and the number of operations may be the number of sliding operations. No specific restriction is made herein.

It should be understood that, in each set of operations generated by the user on the password input key, the operations of one set may be the same operation, for example, all operations of one set are pressing operations or clicking operations. The operations of one set may also be different operations. For example, some operations of one set are pressing operations, and some are sliding operations, which is not specifically limited herein. For example, the operations of one set are the same operation. In the case that the operations of each set are the same operation, the number of operations and/or the operation duration of each set for the password input key may be the same or different, which may be flexibly set according to specific situations.

In an embodiment, the vehicle further includes a display screen. In practical applications, the display screen may be realized by a dashboard of the vehicle. For example, only a single password input key is arranged on the vehicle, for each pressing operation performed on the password input key in each set of operations, the display screen is controlled to display a corresponding value of the number of pressing operations until the pressing operations performed on the password input key in each set of operations are completed. That is, the times the user presses on the password input key is counted, and the display screen is controlled to display the count value. For example, during a set of operations, the password input key is pressed 3 times. When the password input key is pressed for the first time, the count is 1, and the display screen shows the number 1. When the password input key is pressed for the second time, the count is 2, and the display screen shows the number 2. When the password input key is pressed for the third time, the count is 3, and the display screen shows the number 3. The counting is restarted when a new set of operations is performed. In the embodiments of displaying the count value, the user may be reminded of the number of the pressing operations performed on the password input key to allow the user to determine if the number of the operations is correct.

In addition, when only a single password input key is arranged on the vehicle, the duration of one pressing operation in each set is monitored, and the display screen is controlled to display the monitored operation during until the pressing operation performed on the password input key in each set is completed. That is, the duration for which the user presses on the password input key is counted, and the display screen is controlled to display the count value. For example, a set of operations includes one pressing operation performed on the password input key, and a duration of this pressing operation is counted to be 5 s. At this time, the display screen shows the duration of the operation of 5 s. Moreover, the display screen may only show the number and show the duration from 1 s. As long as the pressing operation does not disappear, the duration will continue to be displayed. In the case where the user's pressing operation lasts for 5 seconds, digital numbers 1 to 5 are displayed on the display screen in sequence. That is, the user is reminded of the duration of the pressing operation every second, which improves the user's experience.

In the above embodiments, the vehicle can be activated or turned on according to the input password. In the present disclosure, the vehicle can be activated or turned on by a key, and can be activated or turned on by controlling an App of a mobile phone, and can also be activated or turned on by inputting the password as shown in FIGS. 1 to 3. For ease of description, the vehicle in the embodiments of the present disclosure has three modes, i.e., a key activation mode, a mobile phone activation mode, and a password activation mode. The vehicle may be activated or turned on by any one or two or more of the activation modes. The present disclosure focuses on the password activation mode.

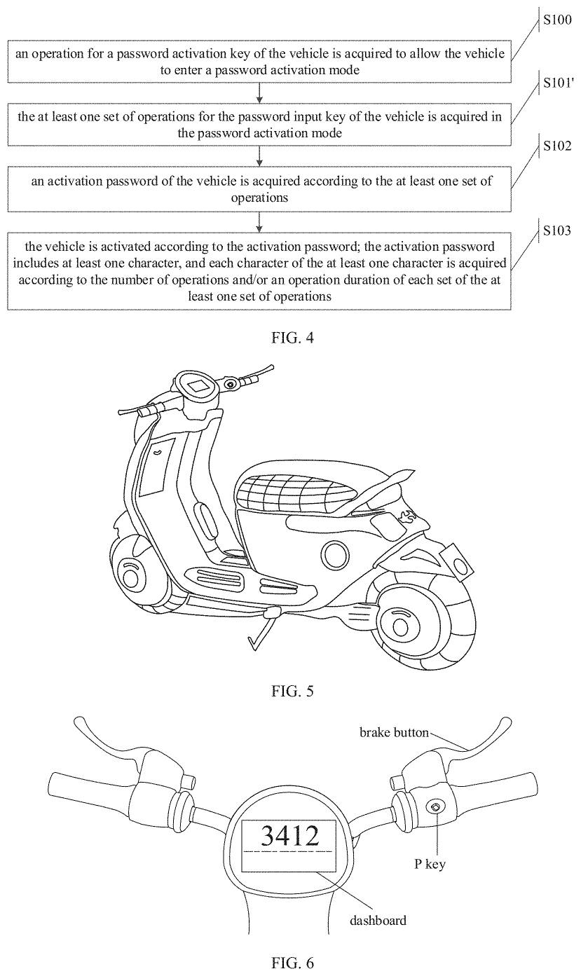

In order to realize the password activation of the vehicle, the vehicle in the embodiments of the present disclosure includes a password activation key, and the password activation key is used for the user to operate to allow the vehicle to enter the password activation mode. As shown in FIG. 4, before S101, the method for activating the vehicle of the present disclosure further includes S100.

In S100, an operation for a password activation key of the vehicle is acquired to allow the vehicle to enter a password activation mode.

In this step, the password activation key can be a physical key or a virtual key, for example a physical button, such as an existing function button on the vehicle. The function button is used as the password activation key when the vehicle is turned off, and the function button is used to realize its original function when the vehicle is turned on. For example, the function key may be a P gear function key on the vehicle. The password activation key may be a key additionally provided on the vehicle, or a key that is multiplexed with other inherent key of the vehicle, such as a switch button. The password activation key and the password input key may be the same key or different keys. Operations of the password activation key may be referred to the operations of the password input key described above. The operations performed on the password activation key are detected or monitored.

It should be understood that once the operation on the password start key is detected or monitored, it indicates that the user desires to use the password to activate or turn on the vehicle. It happens when the user forgets to carry the key or the mobile phone.

Accordingly, the method for activating the vehicle includes the following steps.

In S101′ (corresponding to S101), the at least one set of operations for the password input key of the vehicle is acquired in the password activation mode.

In this step, the vehicle is in the password activation mode, each set of operations performed on the password input key is detected or monitored.

In S102, an activation password of the vehicle is acquired according to the at least one set of operations.

In S103, the vehicle is activated according to the activation password; the activation password includes at least one character, and each character of the at least one character is acquired according to the number of operations and/or an operation duration of each set of the at least one set of operations.

Details of S102 and S103 may be referred to the aforementioned related contents, which will not be repeated here.

S100 and S101′ indicate that only when a user's operation on the password activation key is detected or monitored, that is when the user expects to use the password to activate or turn on the vehicle, each set of operations on the password input key is detected or monitored. S100 and S101′ may identify the user's intention to activate or turn on the vehicle with the password, to allow the operations for activating the vehicle to be performed. In this case, even if the user forgets to carry the mobile phone, the vehicle may be activated according to the user's intention and the password input by the user, which improves the user's experience. The vehicle is provided with an additional function that is capable of activating or turning on the vehicle with the password, which improves intelligent control of the vehicle. In addition, the character(s) constituting the activation password can be determined by the number of operations and/or the duration of the operation of each set of operations performed on the password input key, which improves convenience and flexibility for inputting the password, and thus provides convenience to the user.

As described above, the password activation key and the password input key in the embodiments of the present disclosure may be the same key, or may be a physical key specially arranged. When the password activation key and the password input key are the same physical key, it should be determined whether the operation on the same physical key is an operation which is performed by the user to make the vehicle to enter the password activation mode, or an operation which is performed by the user to input the activation password. In order to distinguish the two purposes, different operations can be designed and used to distinguish the two purposes. For example, a clicking operation on the same key is the operation to enter the password activation mode, and a pressing operation on the same key is the operation to input the activation password. In particular, if the operations are the same, the two purposes can be distinguished by an operation duration. For example, a long pressing operation on the same key is the operation to enter the password activation mode, and a short pressing operation is the operation to input the activation password, and vice versa. Therefore, the password activation key and the password input key may be the same key, as long as the two different purposes can be distinguished. It can be understood that, the pressing operation and the clicking operation in the embodiments of the present disclosure may be different in pressing force and pressing area. The pressing operation may have a greater pressing force and a bigger pressing area than the clicking operation.

Based on the embodiments described above, when the vehicle enters the password activation mode, the method further includes: time-counting to acquire a duration; and when the duration reaches a predetermined duration, exiting the password activation mode if not all operations in the at least one set of operations are acquired. That is, within a predetermined period of time, if the user does not complete operations of all sets performed on the password input key (that is, a whole activation password is not input), the vehicle automatically exits the password activation mode to improve safety of the activation of the vehicle, thus preventing unauthorized users from illegally activating the vehicle. In a specific embodiment, the predetermined duration is a preset reasonable duration, which is the maximum duration in seconds or minutes for inputting the password. Time-counting may be counting down or counting up (opposed to counting down). No matter it is counting down or counting up, once the user has not finished inputting the activation password within the maximum time period (i.e., the predetermined duration), the user may be an unauthorized user, not the owner of the vehicle, and the vehicle exits the password activation mode for the safety and no operation will be executed for activating or turning on the vehicle.

Based on the embodiments described above, when the vehicle enters the password activation mode, the method further includes: time-counting to acquire a duration; and exiting the password activation mode when the duration reaches the predetermined duration. That is, if the vehicle is not activated by a correct password when the predetermined duration is reached, the vehicle automatically exits the password activation mode, and the user cannot input the password through the password input key to activate or turn on the vehicle. In this case, the user is required to input the correct password as soon as possible to avoid the exit of the password activation mode caused by a late input. In practice, if a user who inputs the activation password is an authorized user such as the owner of the vehicle, the user has the ability of correctly inputting the activation password within the predetermined duration, while an unauthorized user such as a thief cannot complete the input within the predetermined duration. Moreover, malicious input of unauthorized users can be avoided.

It should be understood that, after the user inputs the activation password through the password input key, the activation password identified according to the operations performed on the password input key by the user should be confirmed. The following process may be adopted.

Before the vehicle is activated according to the activation password, the present method further includes: acquiring an operation for confirming the activation password; and determining whether the activation password is a correct password according to the acquired operation for confirming the activation password. Accordingly, S103 of activating the vehicle according to the activation password includes: activating the vehicle with the activation password when it is determined that the activation password is the correct password.

The operation for confirming the activation password in the above embodiment may be generated by the user, and the operation generated by the user may be detected or monitored. When the operation, generated by the user, for the activation password input by the user is detected or monitored, and the vehicle may determine that the activation password identified according to the operations performed on the password input key by the user is the correct password, the vehicle can be activated or monitored. In an embodiment, a confirmation key for the user to confirm the activation password may be displayed on the display screen of the vehicle. When an operation such as clicking, pressing and sliding is detected, it is determined that the operation generated by the user for confirming the input activation password is detected or monitored. The confirmation key may be a physical key or a virtual key, and may be set additional or multiplexed with an existing key of the vehicle. For example, the confirmation key is a brake button of the vehicle. After detecting or monitoring all the sets of operations performed by the user, and acquiring the activation password according to the number of operations and/or the operation duration of all the sets, the user grips the brake button. Once the operation of griping the brake button is detected, it indicates that the user's confirmation operation is detected. Then, it is detected whether the activation password input by the examiner is the correct password. If it is the correct password, the vehicle is activated or turned on. As described above, the whole activation password is confirmed, to ensure that the vehicle is activated only in a case that the activation password is correct.

In an embodiment of the present disclosure, in order to achieve timely confirmation of the activation password, a time-counting is performed after the activation password is acquired according to at least one set of operations. When a duration reaches a first threshold, and the operation for confirming the activation password is not acquired, the vehicle exits the password activation mode or determines the activation password to be incorrect, and thus the vehicle is not activated or turned on. The first threshold is a predetermined duration in seconds or minutes, i.e., a maximum duration for the user to perform the confirmation operation. Time-counting may be counting down or counting up (opposed to counting down). No matter it is counting down or counting up, once the user has not finished the confirmation operation within the maximum time period (i.e., the first threshold of the predetermined duration), that is, the confirmation operation is not detected, the vehicle exits the password activation mode for the safety and no operation will be executed for activating or turning on the vehicle, or the vehicle determines the activation password to be incorrect, and there is no need to activate or turn on the vehicle.

Based on the above embodiments of the password confirmation, different cases that the activation password of the present disclosure is a single character, and consists of two or more characters may be described below. In the case that the activation password is the single character, after this character is input, the confirmation operation is used to determine whether the input character is a correct password, that is, to determine whether the activation password is correct by the confirmation operation. In the case that the activation password consists of two or more characters, each character is determined according to operation attribute of a set of operations performed on the password input key, such as the number of operations and the operation duration. After all characters of the activation password is acquired, that is, the last character is acquired, the operation for confirming the activation password is detected and used to verify the password. In other words, the confirmation operation is performed on the whole activation password.

In addition, each character may be verified once each character of the activation password is acquired. The confirmation of the activation password is realized by confirming each character.

In an embodiment, the activation password includes two or more characters, and steps of acquiring an operation for confirming the activation password, and determining whether the activation password is a correct password according to the acquired operation for confirming the activation password include: acquiring a current character of the activation password, and acquiring an operation for confirming the current character; determining that the current character is a correct character according to the acquired operation for confirming the current character; and determining that the activation password is the correct password when each character of the activation password is a correct character. In other words, when any character of the activation password is acquired, it is detected or monitored whether there is the confirmation operation of the character. If the confirmation operation is detected or monitored, the character is regarded as correct. If there is no confirmation operation, the character is regarded as an incorrect character and the vehicle exists the password activation mode. When every character is correct, the activation password is considered to be the correct password. Alternatively, when the character is acquired, the time counting starts. If the counting time reaches the first threshold and the operation for confirming the activation password has not been acquired, the vehicle exists the password activation mode or the acquired activation password is considered as incorrect and there is no need to activate the vehicle. For example, the operation for confirming the activation password (i.e., the confirmation operation) is an operation for the brake button. When each character is acquired, the operation for the brake button, such as griping the brake, is detected, and it indicates that the confirmation operation for each character is detected. After all the characters constituting the activation password are confirmed, the activation password is considered to be the correct password, and the correct password can be used to activate or turn on the vehicle. In the above embodiments, the correctness of the activation password is ensured by confirming each character, thus realizing the activation of the vehicle correctly.

In another embodiment, if the confirmation operation is acquired, and the confirmation operation is used to confirm the completion of a set of operations for a single character, this character is determined according to the set of operations. After the last character of the activation password is determined, the activation password is verified. If the activation password is correct, the vehicle is activated or turned on. Before the last character of the activation password is determined, a set of operations for the password input key of the vehicle is acquired. If the confirmation operation is acquired, and the confirmation operation is used to confirm the completion of a set of operations for a single character, this character is determined according to the set of operations. In this embodiment, the confirmation operation may also be used to confirm whether the character input is completed. When it is confirmed that the character input is completed, the character is determined according to a set of operations for a single character, and the activation password is verified after all characters are determined.

In practical applications, the confirmation operation may be an operation for an existing key of the vehicle, or for a key additionally arranged on the vehicle. The key may be a virtual key or a physical key. For example, the confirmation operation is an operation performed on the brake button of the vehicle (such as griping the brake button). The confirmation operation may be a touch operation performed on the display screen of the vehicle, such as a predetermined number of clicking (clicking the screen twice continuously), sliding and pressing. The kind of the operation is not limited herein, as long as the confirmation can be completed.

Alternatively, the activation password includes two or more characters, and steps of acquiring an operation for confirming the activation password, and determining whether the activation password is a correct password according to the acquired operation for confirming the activation password include: acquiring a current character of the activation password, and acquiring an operation for confirming the current character; and acquiring the operation for confirming the activation password when a last character of the activation password is acquired. In the embodiment of the present disclosure, the completion of the input of each character can be confirmed through the operation for confirming the character. When the input of the last character is completed, the confirmation operation of the input completion of the last character can be regarded as the confirmation operation of the input completion of the whole activation password.

In the embodiments where the vehicle exits the password activation mode, the character input is incorrect or the activation password is incorrect, the display screen of the vehicle may display a prompt of re-inputting the activation password, for example the display screen may re-presents the password input interface. The previously input incorrect activation password is wiped out, and the user may input the activation password again.

The embodiments of the present disclosure will be further described in detail with reference to FIG. 5 and FIG. 6.

In an embodiment, the vehicle is an electric bicycle as shown in FIG. 5, the password input key and the password activation key are the same physical key, which is an existing function key, i.e., P key on the vehicle as shown in FIG. 6. In order to facilitate the operation of the key, it may be set at a position close to a handlebar as shown in FIG. 6. The position may also be any other reasonable position, as long as it is convenient for the user to operate and does not occupy too much space. The display screen is a dashboard of the vehicle.

In this embodiment, considering that the password input key and the password activation key are the same physical key, it is specified in advance that a long pressing operation on the physical key is an operation for entering into the password activation mode, and a short pressing operation is an operation for inputting the activation password. In a specific implementation, if a duration of the pressing operation performed on the physical key reaches a second threshold such as 6 s, it is regarded as the long pressing operation. If it does not reach the second threshold such as 6 s, it is regarded as the short pressing operation. In an embodiment, the characters constituting the activation password are all numbers, for example, the activation password is a four-digit number 3124. The number of sets of the short pressing operations performed on the P key by the user may be the same as the number of characters that constitute the activation password. In this embodiment, the number of sets of short pressing operations performed on the P key by the user is four, and each group of short pressing operations corresponds to one of the numbers of the activation password. The number of operations in each set performed on the P key represents a number of one digit of the four-digit password number.

In the case that the user does not carry the key of the vehicle or the mobile phone, the user can long-press the P key to make the vehicle enter the password activation mode. After entering the password activation mode, four sets of short pressing operations are performed on the P key, and each set of short pressing operations realizes the input of one character of the activation password. After each set of short pressing operations, the user grips the brake button of the vehicle to confirm that the character is input correctly. The activation password correctly input is used to activate or turn on the vehicle.

On the technical level, if the user intends to perform a long pressing operation on the P key, after the user's operation on the P key is detected or monitored, a duration of the operation is timed. If the duration reaches the second threshold, such as 6 s, the current pressing operation for the P key is a long pressing operation. In this case, the user expects to use the activation password to activate or turn on the vehicle, to allow the vehicle to enter the password activation mode. When the vehicle is in the password activation mode, a dashboard lights up and shows the number “0” to remind the user that the password activation mode has been entered and the activation password can be input. The user first inputs a first number “3” in the activation password 3412, that is, shortly presses the P key three times (performs a first set of operations on the password input key). In other words, three operations are performed on the P key, and this current input is considered as the number “3”. During the three short pressing operations, each time the user performs a short pressing operation on the P key, a time counting is performed. If the duration that the operation lasts on the P key does not reach the second threshold, the operation is considered to be a short pressing operation and the user intends to input the activation password. When the vehicle detects one short pressing operation, it will count once and display the count value on the dashboard. For example, in the case of inputting the first number of “3” of the activation password, the user shortly presses the P key three times continuously. For the first short pressing operation on the P key, the dashboard displays the number “1”, for the second short pressing operation on the P key, the dashboard displays the number “2”, and for the third short pressing operation on the P key, the dashboard displays the number “3”. After the number “3” displayed on the dashboard, the user grips the brake button to perform the confirmation operation for confirming that the number that the user intends to input is correct. After the confirmation operation is detected or monitored, the first number of the activation password is considered as to be input correctly, a next number is to be input.

The user inputs the second digit, i.e., “4” of the activation password 3412 by shortly pressing the P key 4 times continuously (i.e., performing the second set of operations on the password input key). In other words, four operations are performed on the P key, and and this current input is considered as the number “4”. During the four short pressing operations, each time the user performs a short pressing operation on the P key, a time counting is performed. If the duration that the operation lasts on the P key does not reach the second threshold, the operation is considered to be a short pressing operation and the user intends to input the activation password. When the vehicle detects one short pressing operation, it will count once and display the count value on the dashboard. For example, in the case of inputting the second number of “4” of the activation password, the user shortly presses the P key four times continuously. For the first short pressing operation on the P key, the dashboard displays the number “1”, for the second short pressing operation on the P key, the dashboard displays the number “2”, for the third short pressing operation on the P key, the dashboard displays the number “3” and for the fourth short pressing operation on the P key, the dashboard displays the number “4”. After the number “4” displayed on the dashboard, the user grips the brake button to perform the confirmation operation for confirming that the number that the user intends to input is correct. After the confirmation operation is detected or monitored, the second number of the activation password is considered as to be input correctly, a next number is to be input. In this way, the third number “1” and the fourth number “2” are input into the vehicle and the four numbers are integrated into the vehicle to acquire the activation password “3412”. This password identified by the vehicle is compared with the predetermined activation password for the vehicle. When they are the same, the vehicle is activated or turned on by this activation password. That is, when the correct activation password “3412” is input, the vehicle is activated normally and may be driven away by the user.

It will be appreciated that in order to facilitate the implementation of the embodiments of the present disclosure, the predetermining of the activation password is required, which may be performed by an interaction of the mobile phone and an APP of the vehicle, or may be performed at a vehicle terminal directly to realize the presetting of the activation password. In the above embodiments, the confirmation operation (griping the brake button) is performed to every character input by the user, and after all the characters are confirmed, they (i.e., the identified activation password) are compared with the predetermined activation password. If the input password is the same with the predetermined password, the vehicle is activated or turned on. In this case, a dual authentication or verification of the activation password input by the user is realized. With the dual authentication or verification, the accuracy of the input password is improved, and a malicious input is avoided.

In the above embodiments, the operation for the brake button (i.e., griping the brake button) is used as the confirmation operation, and the confirmation operation is used to determine whether the input character is correct. In addition, the confirmation operation may also be used to confirm whether the input of the character is completed. For example, for the first number “3”, when the continuous short pressing operations on the P key are detected and the confirmation operation is detected, the input of the first character is completed. After the input of the last character of the activation password is completed, the password verification is performed.

With the technical solutions of the embodiments of the present disclosure, even if the user forgets to carry a key or a mobile phone, it is possible to realize the activation of the vehicle, thus improving the user's experience. The vehicle is provided with an additional function that is capable of activating or turning on the vehicle with the password, which improves intelligent control of the vehicle. In addition, the character(s) constituting the activation password can be determined by the number of operations and/or the duration of the operation of each set of operations performed on the password input key, which improves convenience and flexibility for inputting the password, and thus provides convenience to the user.

In the above embodiments, it is also possible to perform a counting down after the vehicle enters the password activation mode. When the four sets of short pressing operations on the P key are not detected, i.e., the operations for inputting all the characters are not detected, within a maximum countdown duration (i.e., the predetermined duration) that allows the input of the activation password, the vehicle exits the password activation mode for security, and the activation of the vehicle will not be performed. The current user who has not finished inputting the activation password within the predetermined duration is an unauthorized user, i.e., not the owner of the vehicle, and the vehicle exits the password activation mode to prevent the vehicle from being stolen.

In the above embodiments, during the input of the four-digit password, if the duration counted from when the character of the password is identified reaches a first threshold, such as 2 s, and no confirmation operation (such as griping the brake button) is detected for the character (i.e., the number), the current number of the password is considered to be incorrect. In this case, the currently displayed number is wiped out from the dashboard, the number “0” is displayed, and the user may input the number of the password again. Alternatively, the vehicle exits the password activation mode, and will enter the password activation mode again by the user.

In general, the above embodiments describe that the vehicle enters the password activation mode according to the long pressing operation performed by the user, for example, on the P key or any other reasonable key. Each number of the activation password may be input by tapping the P key. When the vehicle is in the password activation mode, the dashboard displays the number “0”. By tapping on the P key for one time, the number displayed on the dashboard is increased from 0 to 9 gradually. That is, the P key is pressed for a number of times, and the number is equal to a value of the number of the password. After every number is identified, it is determined whether the current number of the password is correctly input by griping the brake button. All the four numbers are input in this way. If the gripping operation on the brake button is performed for all the four numbers of the password, it is determined that the input activation password is correct and the vehicle is activated. If an error occurs, the vehicle exits the password activation mode, and the current number on the dashboard is wiped out and the number “0” is displayed, such that the user may re-input the password. The re-input of the password may require the vehicle to enter the password activation mode. If the input activation password is correct, the vehicle is activated, and the user may be reminded of activating the vehicle with prompt information. For example, boot animation and sound, a color of a status indicator of a handlebar of the vehicle is used to remind the user of the activation of the vehicle or the complication of the activation of the vehicle. Further, the counting down may start once vehicle enters the password activation mode. If the duration reaches 1 min and the input of the password is still not completed, the vehicle exits the password activation mode.

In practical applications, it is also possible that the dashboard only displays a single character at a time, that is, the dashboard displays a current character which is input by the user. In this case, if the character is correct, or the input of the character of the activation password is confirmed, the number displayed on the dashboard can be changed from the current number to the number “0”, to facilitate the input of a next character.

In the above embodiments, the character of the activation password is a number. It is also possible that the character of the activation password is a letter. When three short pressing operations on the P key (i.e., the first set of operations on the password input key) are detected, according to the first corresponding relationship, it can be determined that the first character of the activation password is a letter “C” (based on the normal order of the letter). When four short pressing operations on the P key (i.e., the second set of operations on the password input key) are detected, according to the first corresponding relationship, it can be determined that the second character of the activation password is a letter “D” (based on the normal order of the letter). In this way, it can be determined that the third character of the activation password is a letter “A” and the fourth character of the activation password is a letter “B”. The activation password is CDAB. Therefore, based on the number of operations performed on the password input key, automatic identification of numeric or letter password is realized, which is easy to realize in engineering and may be widely applied.

In the above embodiments, the automatic identification of the activation password is performed according to the number of operations performed on the P key. It is also possible to perform the automatic identification of the activation password according to the duration of the operation performed on the P. For example, the activation password may still be 3412. When the user first inputs the first number “3” of the activation password 3412, the user presses the P key for 3 seconds (i.e., performs the first set of operations on the password input key), and time-counting starts to detect a duration of the pressing operation on the P key. When a release of the P key is not detected during 1 s, the number displayed on the dashboard is changed from an initial number 0 to the number 1, to remind the user that the P key has been pressed for 1 s. When the duration reaches 2 s, the dashboard displays the number 2. When the duration reaches 3 s, the dashboard displays the number 3. At this time, the user releases the P key. When the user inputs the second number “4” of the activation password 3412, the user presses the P key for 4 s (i.e., performs the second set of operations on the password input key), and time-counting starts to detect the duration of the pressing operation on the P key. When the release of the P key is not detected during 1 s, the number displayed on the dashboard is changed from an initial number 0 to the number 1, to remind the user that the P key has been pressed for 1 s. When the duration reaches 2 s, the dashboard displays the number 2. When the duration reaches 3 s, the dashboard displays the number 3. When the duration reaches 4 s, the dashboard displays the number 4. At this time, the user releases the P key. In this way, the remaining numbers can be input. The automatic identification of the activation password is realized according to the operation duration for the password input key, which is easy to realize in engineering and may be widely applied.

It should be understood that for each set of operations performed on the password input key, if the identification of the activation password is performed according to the number of operations, each set of operations may include one, two or more operations on the password input key; if the identification of the activation password is performed according to the operation duration, each set of operations may only include one operation (such as pressing, clicking and sliding) performed on the password input key, to simplifying the use of the operation duration to identify the activation password.

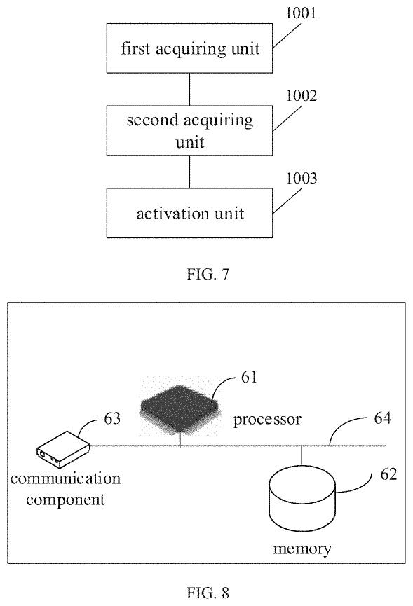

The present disclosure also provides an apparatus for activating a vehicle. As shown in FIG. 7, the apparatus includes a first acquiring unit 1001, a second acquiring unit 1002 and an activation unit 1003.

The first acquiring unit 1001 is configured to acquire at least one set of operations for a password input key of the vehicle. The password input key is used for a user to input an activation password.

The second acquiring unit 1002 is configured to acquire the activation password of the vehicle according to the at least one set of operations

The activation unit 1003 is configured to activate the vehicle according to the activation password.

The activation password includes at least one character, and each character of the at least one character is acquired according to the number of operations and/or an operation duration of each set of the at least one set of operations.

In an embodiment, the second acquiring unit 1002 of the apparatus is configured to acquire an operation for a password activation key of the vehicle, to allow the vehicle to enter a password activation mode.

Accordingly, the first acquiring unit 1001 is configured to acquire the at least one set of operations for the password input key of the vehicle in the password activation mode.

In an embodiment, the apparatus includes a third acquiring unit configured to acquire an operation for confirming the activation password; and determine whether the activation password is a correct password according to the acquired operation for confirming the activation password.

Accordingly, the activation unit 1003 is configured to activate the vehicle with the activation password when it is determined that the activation password is the correct password.

In an embodiment, the activation password includes two or more characters, and the third acquiring unit is configured to acquire a current character of the activation password, and acquire an operation for confirming the current character; determine that the current character is a correct character according to the acquired operation for confirming the current character; and determine that the activation password is the correct password when each character of the activation password is a correct character.

In an embodiment, the activation password includes two or more characters, and the third acquiring unit is configured to acquire a current character of the activation password, and acquire an operation for confirming the current character; and acquire the operation for confirming the activation password when a last character of the activation password is acquired.

In an embodiment, each character independently is a value of the number of operations performed on the password input key in each set of operations, or a letter corresponding to the number of operations; and/or each character independently is a value of a duration of an operation performed on the password input key in each group of operations, or a letter corresponding to the duration of the operation.

In an embodiment, the vehicle further includes a display screen. The operation performed on the password input key in each set of operations is at least one pressing operation, and in each set of operations, every time the pressing operation is performed on the password input key, the display screen is controlled to display a corresponding value of the number of pressing operations until the pressing operations performed on the password input key in each set of operations are completed.

In an embodiment, the operation performed on the password input key in each set is the pressing operation, and the operation duration of one pressing operation in each set is monitored. The display screen is configured to display the monitored operation duration until the pressing operation in each set performed on the password input key is completed.

In an embodiment, the operation for confirming the activation password is an operation for a brake button of the vehicle, and/or a touch operation for a display screen of the vehicle.

In the apparatus embodiments of the present disclosure, the display screen may be a dashboard of the vehicle, the password input key and the password activation key may be the same key or different keys. For example, the password input key and the password activation key may both be a switch key of the vehicle. It is also possible that the password activation key is the switch key of the vehicle, and the password input key is a specially arranged key for inputting the password.

It should be understood that in practice applications the first acquiring unit 1001, the second acquiring unit 1002, the activation unit 1003, and the third acquiring unit of the apparatus may be implemented by a central processing unit (CPU), a digital signal processor (DSP), a microcontroller unit (MCU) or a programmable gate array (FPGA) of the vehicle.

It should be noted that all of the above described features and advantages for the method as described above are also applicable to the apparatus, which will not be elaborated in detail herein.

The present disclosure also provides a non-transitory computer-readable storage medium having stored therein a computer program that, when executed by a processor, is configured to perform steps of any one of the methods as shown in FIGS. 1 to 6. The computer-readable storage medium may be a memory, for example, a memory as shown in FIG. 8.

FIG. 8 is a schematic diagram of hardware configuration of a device for activating a vehicle according to an embodiment of the present disclosure. As shown in FIG. 8, a device for activating a vehicle includes a communication component 63 configured to transmit data, at least one processor 61 and a memory 62 having stored herein a computer program which is executable by the processor 62. All elements in the terminal are coupled by a bus system 64. It should be understood that the bus system 64 is used to realize connection and communication among these components. In addition to a data bus, the bus system 64 also includes a power bus, a control bus, and a status signal bus. For clear description, various buses are marked as the bus system 64 in FIG. 8.

The computer program is executed by the processor 62 to cause the processor 62 to perform steps of any one of the methods as shown in FIGS. 1 to 6.

It should be understood that the memory 62 may be a volatile memory or a non-volatile memory, or may include both volatile and non-volatile memory. The non-volatile memory may be a read-only memory (ROM), a programmable read-only memory (PROM), an erasable programmable read-only memory (EPROM), an electrically EPROM (EEPROM), a ferromagnetic random access memory (FRAM), a flash memory, a magnetic surface memory, a CD or a CD-ROM. The magnetic surface memory may be a disk memory or a tape memory. The volatile memory may be a random access memory (RAM), which is used as an external cache. By way of exemplary but not restrictive description, many forms of RAM are available, such as a static RAM (SRAM), a synchronous SRAM (SSRAM), a dynamic RAM (DRAM), a synchronous DRAM (SDRAM), a double data rate SDRAM (DDRSDRAM), an enhanced SDRAM (ESDRAM), a synch link DRAM (SLDRAM) and a direct Rambus RAM (DRRAM). It should be noted that the memory 62 of embodiments described herein may include, but are not limited to, these and any other suitable types of memories.

The method disclosed in the embodiments of the present disclosure may be applied to the processor 61 or realized by the processor 61. The processor 61 may be an integrated circuit chip with signal processing capability. In practice, the steps of the above methods may be realized by a hardware such as an integrated logic circuit or a software, such as an instruction in the processor 61. The above processor 61 may be a general-purpose processor, a DSP, an application specific integrated circuit (ASIC), an FPGA or other programmable logic device, discrete gate or transistor logic device or a discrete hardware component. Methods, steps, and logical block diagrams disclosed in the embodiments of the present disclosure may be implemented or executed by the processor 61. The general-purpose processor may be a microprocessor or any conventional processor. The operations of the method disclosed in the embodiments of the present disclosure may be executed and completed by a hardware decoding processor, or executed and completed by a combination of hardware and software modules in the decoding processor. The software module may be provided in a storage medium. The storage medium is stored in the memory 62, and the processor 61 reads the information in the memory 62 to perform the steps/operations of the above method in combination with the hardware.

In an embodiment, the device for activating the vehicle may be implemented by one or more of an ASIC, a DSP, a programmable logic device (PLD), a complex PLD (CPLD), a FPGA, a general-purpose processor, a controller, a MCU, a microprocessor, or other electronic components to perform any of the above methods for activating the vehicle.

It should be understood that the methods, apparatuses and devices of the embodiments of the present disclosure may be implemented in other ways. For example, the device embodiments described above are only illustrative. For example, the division of the components is only a logical function division, and there may be other divisions in actual implementations, for example, multiple units or components may be combined or integrated into another system, or some features may be ignored or not implemented. In addition, unless specified or limited otherwise, the terms “communicated,” “connected,” “coupled,” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

The elements described as separate components may or may not be physically separated, and the component displayed as a unit may or may not be a physical unit, that is, the component may be located in one place, or it may be distributed on multiple network units. Some or all of the units may be selected according to actual needs to achieve the object of the embodiments. In addition, the functional units in the various embodiments of the present disclosure may be integrated into one processing unit, or each unit may exist alone physically, or two or more units may be integrated into one unit.

In addition, the functional units in the embodiments of the present disclosure may be all integrated into one processing unit, or each unit may be used as a separate unit, or two or more units can be integrated into one unit. The above integrated unit may be realized in a form of hardware or in a form of hardware in combination with software functional units.

It should be understood that all or portion of the steps in the above method embodiments may be performed by a hardware associated with program instructions. The program may be stored in a computer-readable storage medium. When the program is executed, the steps of the above method are performed. The above storage medium includes: a removable storage device, a read-only memory (ROM), a random access memory (RAM), a magnetic disk, an optical disk and any other medium that is able to store program codes.

Alternatively, if the above-mentioned integrated unit of the present disclosure is implemented by a software function module and sold or used as an independent product, it may also be stored in a computer-readable storage medium. Based on this understanding, the technical solutions of the embodiments or a part that contributes to the prior art of the present disclosure may be embodied in the form of a software product. The computer software product is stored in a storage medium and includes instructions that when executed by a computer device (which may be a personal computer, a server, or a network device, etc.) cause the computer device to perform all or part of the steps of the method described in the various embodiments of the present disclosure. The above storage medium may be a mobile storage device, a ROM, a RAM, a magnetic disk, an optical disk or any other medium that can store program codes.

The features disclosed in the method embodiments of the present disclosure may be combined without conflict to obtain new method embodiments.

The features disclosed in the product embodiments of the present disclosure may be combined without conflict to obtain new product embodiments.

The features disclosed in method, apparatus or device embodiments of the present disclosure may be combined without conflict to obtain new method, apparatus or device embodiments.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example” “in a specific example” or “in some examples” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from scope of the present disclosure. Therefore, the protection scope of the present disclosure should be in accordance to the protection scope of the claims.

What is claimed is:

1. A method for activating a vehicle, comprising:
acquiring at least one set of operations for a password input key of the vehicle;
acquiring an activation password of the vehicle according to the at least one set of operations; and
activating the vehicle according to the activation password;
wherein the activation password comprises at least one character, and each character of the at least one character is acquired according to the number of operations and/or an operation duration of each set of the at least one set of operations.

2. The method according to claim 1, wherein the method further comprises:
acquiring an operation for a password activation key of the vehicle, to allow the vehicle to enter a password activation mode; and
acquiring the at least one set of operations for the password input key of the vehicle in the password activation mode.

3. The method according to claim 1, wherein before activating the vehicle according to the activation password, the method further comprises:
acquiring an operation for confirming the activation password; and
determining whether the activation password is a correct password according to the acquired operation for confirming the activation password;
wherein activating the vehicle according to the activation password comprises:
activating the vehicle with the activation password when it is determined that the activation password is the correct password.

4. The method according to claim 3, wherein the activation password comprises two or more characters, and
wherein acquiring an operation for confirming the activation password; and determining whether the activation password is a correct password according to the acquired operation for confirming the activation password comprise:
acquiring a current character of the activation password, and acquiring an operation for confirming the current character;
determining that the current character is a correct character according to the acquired operation for confirming the current character; and
determining that the activation password is the correct password when each character of the activation password is a correct character.

5. The method according to claim 3, wherein the activation password comprises two or more characters, and
wherein acquiring an operation for confirming the activation password; and determining whether the activation password is a correct password according to the acquired operation for confirming the activation password comprise:
acquiring a current character of the activation password, and acquiring an operation for confirming the current character; and
acquiring the operation for confirming the activation password when a last character of the activation password is acquired.

6. The method according to claim 1, wherein each character independently is a value of the number of operations performed on the password input key in each set of operations, or a letter corresponding to the number of operations.

7. The method according to claim 1, wherein each character independently is a value of a duration of an operation performed on the password input key in each group of operations, or a letter corresponding to the duration of the operation.

8. The method according to claim 2, wherein when the vehicle enters the password activation mode, the method further comprises:
time-counting to acquire a duration; and
when the duration reaches a predetermined duration,
exiting the password activation mode if not all operations in the at least one set of operations are acquired.

9. The method according to claim 2, wherein when the vehicle enters the password activation mode, the method further comprises:
time-counting to acquire a duration; and
exiting the password activation mode when the duration reaches the predetermined duration.

10. The method according to claim 6, wherein the vehicle further comprises a display screen; and
wherein the operation performed on the password input key in each set of operations is at least one pressing operation, and in each set of operations, every time the pressing operation is performed on the password input key, the display screen is controlled to display a corresponding value of the number of pressing operations until the pressing operations performed on the password input key in each set of operations are completed.

11. The method according to claim 3, wherein the operation for confirming the activation password is an operation for a brake button of the vehicle, and/or a touch operation for a display screen of the vehicle.

12. A non-transitory computer-readable storage medium having stored therein a computer program that, when executed by a processor, is configured to perform a method for activating a vehicle, the method comprising:
acquiring at least one set of operations for a password input key of the vehicle;
acquiring an activation password of the vehicle according to the at least one set of operations; and
activating the vehicle according to the activation password;
wherein the activation password comprises at least one character, and each character of the at least one character is acquired according to the number of operations and/or an operation duration of each set of the at least one set of operations.

13. The non-transitory computer-readable storage medium according to claim 12, wherein the method further comprises:
acquiring an operation for a password activation key of the vehicle, to allow the vehicle to enter a password activation mode; and
acquiring the at least one set of operations for the password input key of the vehicle in the password activation mode.

14. The non-transitory computer-readable storage medium according to claim 12, wherein before activating the vehicle according to the activation password, the method further comprises:
acquiring an operation for confirming the activation password; and
determining whether the activation password is a correct password according to the acquired operation for confirming the activation password;
wherein activating the vehicle according to the activation password comprises:
activating the vehicle with the activation password when it is determined that the activation password is the correct password.

15. A device for activating a vehicle, comprising:
a processor;
a memory having stored herein a computer program that, when executed by the processor, causes the processor to perform a method for activating a vehicle, the method comprising:
acquiring at least one set of operations for a password input key of the vehicle;
acquiring an activation password of the vehicle according to the at least one set of operations; and
activating the vehicle according to the activation password;
wherein the activation password comprises at least one character, and each character of the at least one character is acquired according to the number of operations and/or an operation duration of each set of the at least one set of operations.

16. The device according to claim 15, wherein the method further comprises:
acquiring an operation for a password activation key of the vehicle, to allow the vehicle to enter a password activation mode; and
acquiring the at least one set of operations for the password input key of the vehicle in the password activation mode.

17. The device according to claim 15, wherein before activating the vehicle according to the activation password, the method further comprises:
acquiring an operation for confirming the activation password; and
determining whether the activation password is a correct password according to the acquired operation for confirming the activation password;
wherein activating the vehicle according to the activation password comprises:
activating the vehicle with the activation password when it is determined that the activation password is the correct password.

18. The device according to claim 17, wherein the activation password comprises two or more characters, and
wherein acquiring an operation for confirming the activation password; and determining whether the activation password is a correct password according to the acquired operation for confirming the activation password comprise:
acquiring a current character of the activation password, and acquiring an operation for confirming the current character;
determining that the current character is a correct character according to the acquired operation for confirming the current character; and
determining that the activation password is the correct password when each character of the activation password is a correct character.

19. The device according to claim 17, wherein the activation password comprises two or more characters, and
wherein acquiring an operation for confirming the activation password; and determining whether the activation password is a correct password according to the acquired operation for confirming the activation password comprise:
acquiring a current character of the activation password, and acquiring an operation for confirming the current character; and
acquiring the operation for confirming the activation password when a last character of the activation password is acquired.

20. The device according to claim 16, wherein when the vehicle enters the password activation mode, the method further comprises:
time-counting to acquire a duration; and
when the duration reaches a predetermined duration,
exiting the password activation mode if not all operations in the at least one set of operations are acquired.
